(19) United States
(12) Patent Application Publication
(10) Pub. No.: US 2026/0174167 A1
(43) Pub. Date: Jun. 25, 2026

(54) ROTATABLE CHRISTMAS TREE

(71) Applicant: DONGYANG ZHENHONG CRAFTS CO., LTD., Jinhua (CN)

(72) Inventor: XIANPING LUO, Jinhua (CN)

(21) Appl. No.: 19/536,931

(22) Filed: Feb. 11, 2026

(30) Foreign Application Priority Data
Jan. 30, 2026 (CN) 202610134352.9

(51) Int. Cl. A41G 1/00; A47G 33/04; A47G 33/06; A47G 33/08; A47G 33/12; F21V 23/00

(52) U.S. Cl. CPC A41G 1/007; A47G 33/045; A47G 33/06; A47G 33/0881; A47G 33/12; A47G 33/1206; A47G 33/1213; A47G 33/126; F21V 23/002; A47G 2033/1266; A47G 2033/1273; A47G 2033/1286; A47G 2033/1293

(57) ABSTRACT

The present disclosure discloses a rotatable Christmas tree, including a support rod assembly, a frame assembly, and a motor, where the support rod assembly includes a support rod base and a support rod fixedly connected to the support rod base; the frame assembly includes a frame and Christmas tree ornaments disposed on the frame, and the frame is provided with a connecting ring at a top; the motor is disposed at a top of the support rod, and a motor shaft of the motor is connected to the connecting ring. When the motor rotates, the motor drives the connecting ring to cause the frame and the Christmas tree ornaments on the frame to rotate, thereby providing viewers with more dynamic viewing experiences. Compared to rotatable Christmas trees available on the market, the Christmas tree provided in this technical solution has fewer parts, and the assembly between parts is simpler.

### TECHNICAL FIELD

The present disclosure relates to the technical field of Christmas trees, and in particular to a rotatable Christmas tree.

### BACKGROUND

Currently, with the continuous introduction of Western culture into China, Christmas is gradually becoming popular. As an indispensable decoration for Christmas both domestically and abroad, a Christmas tree enhances the festive atmosphere with its beautiful appearance. The Christmas tree refers to an evergreen tree, such as a fir or pine, that is decorated with lights and ornaments. In modern times, the Christmas tree originated in Germany and later gradually gained popularity worldwide, becoming one of the most famous traditions in Christmas celebrations.

As real Christmas trees require frequent maintenance and watering and are difficult to keep alive, coupled with the increasing occasions for using Christmas trees to beautify environments and enhance festive atmospheres, such as homes, outdoor courtyards, mall entrances, city squares, and high-end hotels, the demand for artificial Christmas trees has consequently increased. The artificial Christmas trees do not require manual maintenance, watering, pruning, or pest control, may be used for a long term, and may be combined and matched according to personal preferences to create different environmental atmospheres and enhance festive joy.

Regarding the above related technologies, the inventor believes that the following deficiencies exist: existing artificial Christmas trees sold on the market or homemade Christmas trees are static, which fails to provide viewers with more dynamic viewing experiences. Additionally, some rotatable Christmas trees available on the market typically have rotation mechanisms arranged at bottoms of the trees. Their structures are relatively complex and involve many parts, making assembly during production cumbersome.

### SUMMARY

To solve the above problems, the present disclosure provides a rotatable Christmas tree.

The technical solution employed in the present disclosure is as follows: A rotatable Christmas tree includes:
a support rod assembly, where the support rod assembly includes a support rod base and a support rod fixedly connected to the support rod base;
a frame assembly, where the frame assembly includes a frame and Christmas tree ornaments disposed on the frame, and the frame is provided with a connecting ring at a top; and
a motor, where the motor is disposed at a top of the support rod, and a motor shaft of the motor is connected to the connecting ring; and when the motor rotates, the motor drives the connecting ring to cause the frame and the Christmas tree ornaments on the frame to rotate.

Further, a support plate is fixedly connected to the motor shaft; and when the frame assembly is sleeved onto the motor shaft through the connecting ring, the support plate contacts the connecting ring.

Further, a motor mounting base is sleeved onto the top of the support rod, and the motor is disposed on the motor mounting base.

Further, the motor is connected to a power assembly through a conductor wire, and the power assembly includes a storage battery and a switch for controlling the motor.

Further, the conductor wire extends downward to a connecting point between the support rod base and the support rod.

Further, the frame includes a plurality of bracket units, the connecting ring is disposed on a central portion of each of the bracket units, and a plurality of fixing rods are disposed between the connecting ring and the bracket unit; and when the frame is mounted onto the support rod, the support rod passes through the connecting ring on the bracket unit.

Further, the bracket units are connected to each other through connecting ropes, a plurality of clips are fixedly connected to the connecting ropes, and the connecting ropes are connected to the bracket units through the clips.

Further, each of the clips includes a detent opening configured to be snapped into the bracket unit, and an opening is formed on a side of the detent opening.

Further, the support rod base includes a first base and a second base, and the first base and the second base are rotatably connected.

Further, the bracket unit is circular in shape; and the frame includes the plurality of bracket units with different diameters, the diameters of the bracket units are decreased sequentially from top to bottom, and the frame formed by the bracket units is conical in shape.

Compared with the prior art, the present disclosure has the following beneficial effects: The present disclosure provides a rotatable Christmas tree, including a support rod assembly, a frame assembly, and a motor, where the support rod assembly includes a support rod base and a support rod fixedly connected to the support rod base; the frame assembly includes a frame and Christmas tree ornaments disposed on the frame, and the frame is provided with a connecting ring at a top; the motor is disposed at a top of the support rod, and a motor shaft of the motor is connected to the connecting ring. When the motor rotates, the motor drives the connecting ring to cause the frame and the Christmas tree ornaments on the frame to rotate, thereby providing viewers with more dynamic viewing experiences. Additionally, compared to rotatable Christmas trees available on the market, the Christmas tree provided in this technical solution has fewer parts, and the assembly between parts is simpler. Rotation is achieved merely by adding the motor on the support rod to cooperate with the connecting ring on the frame, with lower production and processing costs.

### BRIEF DESCRIPTION OF THE DRAWINGS

In order to explain the technical solution in embodiments of the present disclosure or in the prior art more clearly, the drawings to be used in the embodiments or the prior art will be briefly introduced below. Obviously, the drawings described below are only some embodiments of the present disclosure. For those of ordinary skill in the art, other drawings may be obtained based on structures shown in these drawings without making creative efforts.

FIG. 1 is a schematic structural view of a rotatable Christmas tree according to the present disclosure.

FIG. 2 is a schematic diagram of a connection between a bracket unit and a motor in a rotatable Christmas tree according to the present disclosure.

FIG. 3 is an enlarged view of a portion A in FIG. 1.

FIG. 4 is an enlarged view of a portion B in FIG. 1.

FIG. 5 is a schematic structural view of a support rod base in a rotatable Christmas tree according to the present disclosure.

Reference numerals in the figures: 1—support rod assembly; 11—support rod base; 12—support rod, 13—motor mounting base; 14—conductor wire; 15—power assembly; 16—first base; 17—second base; 2—frame; 21—bracket unit; 22—fixing rod; 23—connecting ring; 231—insertion hole; 24—connecting rope; 25—clip; 26—detent opening; 27—opening; 3—motor; 31—motor shaft; and 32—support plate.

The achievement of the objectives, functional features, and advantages of the present disclosure will be further explained with reference to the drawings in combination with embodiments.

### DETAILED DESCRIPTIONS OF THE EMBODIMENTS

The technical solutions in embodiments of the present disclosure will be clearly and completely described below in combination with the drawings in the embodiments of the present disclosure. It is obvious that the described embodiments are only a part of, rather than all of, the embodiments of the present disclosure. Based on the embodiments in the present disclosure, all other embodiments obtained by those of ordinary skill in the art without making creative efforts will fall within the protection scope of the present disclosure.

It should be noted that all directional indications (such as up, down, left, right, front, and back) are used only to explain the relative positional relationships and movements among various components under a specific posture (as shown in the drawings). When the specific posture changes, the directional indications will change accordingly.

Additionally, descriptions involving “first”, “second”, and the like are for descriptive purposes only and are not to be construed as indicating or implying relative importance or implicitly specifying the quantity of the indicated technical features. Thus, features defined by “first” or “second” may explicitly or implicitly include at least one of such features. Moreover, the technical solutions among different embodiments may be combined with each other, provided that such combination can be implemented by those of ordinary skill in the art. When a combination of technical solutions results in mutual contradiction or impossibility of implementation, it should be considered that this combination does not exist and is not within the protection scope claimed by the present disclosure.

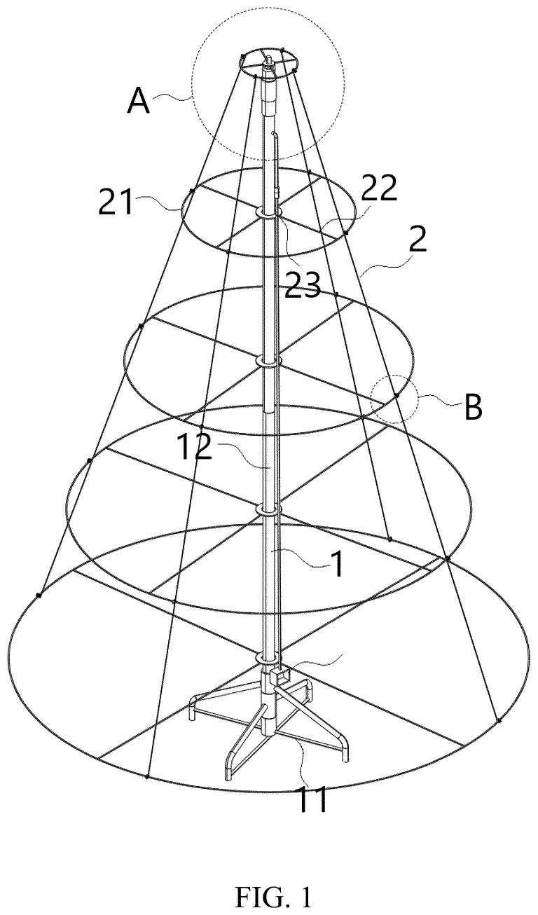

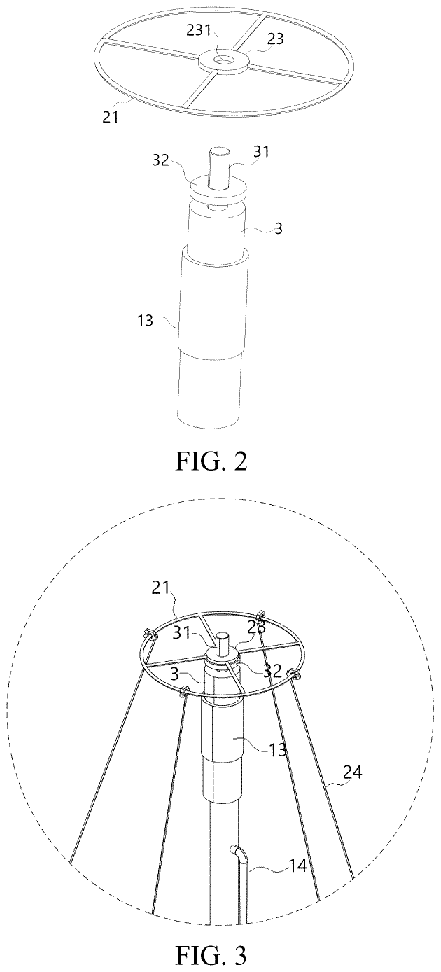

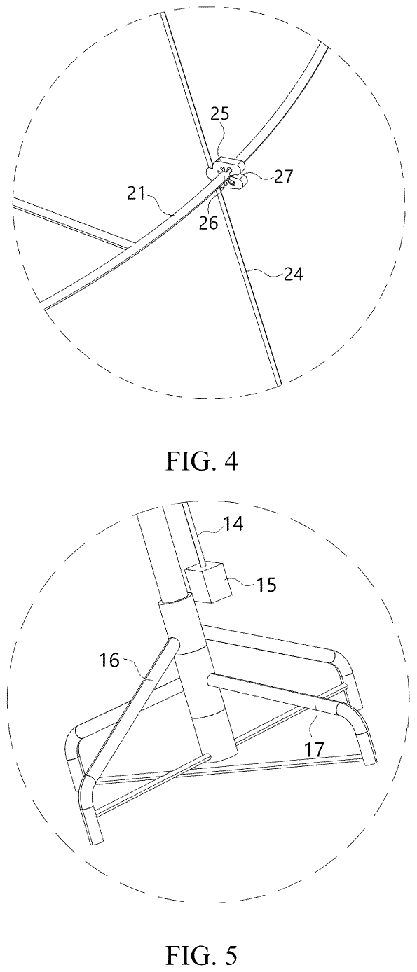

With reference to FIGS. 1 to 5, the present disclosure provides a rotatable Christmas tree, including a support rod assembly 1, a frame assembly, and a motor 3, where the support rod assembly 1 includes a support rod base 11 and a support rod 12 fixedly connected to the support rod base 11; the frame assembly includes a frame 2 and Christmas tree ornaments disposed on the frame, and the frame 2 is provided with a connecting ring 23 at a top; the motor 3 is disposed at a top of the support rod 12, and a motor shaft 31 of the motor 3 is connected to the connecting ring 23. When the motor 3 rotates, the motor 3 drives the connecting ring 23 to cause the frame 2 and the Christmas tree ornaments on the frame 2 to rotate, thereby providing viewers with more dynamic viewing experiences. Additionally, compared to rotatable Christmas trees available on the market, the Christmas tree provided in this technical solution has fewer parts, and the assembly between parts is simpler. Rotation is achieved merely by adding the motor on the support rod to cooperate with the connecting ring on the frame, with lower production and processing costs.

As a preferred implementation of this embodiment, a support plate 32 is fixedly connected to the motor shaft 31. When the frame assembly is sleeved onto the motor shaft 31 through the insertion hole 231 of the connecting ring 23, the support plate 32 contacts the connecting ring 23. As the Christmas tree ornaments on the frame 2 have a certain weight, the support plate 32 supports the frame 2 and the Christmas tree ornaments through the connecting ring 23. The friction between the support plate 32 and the connecting ring 23 is relatively high, making the two less prone to sliding. Therefore, when the motor 3 drives the support plate 32 to rotate, the support plate 32 may drive the connecting ring 23 to rotate. Employing the above connection method may effectively prevent the motor 3 from jamming due to contact with other objects during rotation, thereby avoiding any adverse impact on the service life of the motor. When the frame 2 and the Christmas tree ornaments contact and are jammed by external objects, the motor 3 may continue to drive the support plate 32 to rotate.

Specifically, a motor mounting base 13 is sleeved onto the top of the support rod 12, and the motor 3 is disposed on the motor mounting base 13, thereby facilitating assembly.

Specifically, the motor 3 is connected to a power assembly 15 through a conductor wire 14, and the power assembly 15 includes a storage battery and a switch for controlling the motor 3, where the switch may be a manual switch or a remote-control switch.

Specifically, the conductor wire 14 extends downward to a connecting point between the support rod base 11 and the support rod 12.

As a preferred implementation of this embodiment, the frame 2 includes a plurality of bracket units 21, the connecting ring 23 is disposed on a central portion of each of the bracket units 21, and a plurality of fixing rods 22 are disposed between the connecting ring 23 and the bracket unit 21; and when the frame 2 is mounted onto the support rod 12, the support rod 12 passes through the connecting ring 23 on the bracket unit 21.

Specifically, the bracket units 21 are connected to each other through connecting ropes 24, a plurality of clips 25 are fixedly connected to the connecting ropes 24, and the connecting ropes 24 are connected to the bracket units 21 through the clips 25. Using the connecting ropes 24 to connect and fix the bracket units 21 allows the frame 2 to be folded through stacking of the bracket units 21, thereby reducing storage and transportation volume and lowering transportation costs.

Specifically, each of the clips 25 includes a detent opening 26 configured to be snapped into the bracket unit 21, and an opening 27 is formed on a side of the detent opening 26. During assembly, the clip 25 may be pressed and snapped into the bracket unit 21 through the opening 27, thereby facilitating convenient assembly.

As a preferred implementation of this embodiment, the support rod base 11 includes a first base 16 and a second base 17, and the first base 16 and the second base 17 are rotatably connected, thereby reducing the storage volume of the support rod base 11.

As another preferred implementation of this embodiment, the bracket unit 21 is circular in shape; and the frame 2 includes the plurality of bracket units 21 with different diameters, the diameters of the bracket units 21 are decreased sequentially from top to bottom, and the frame 2 formed by the bracket units 21 is conical in shape. The Christmas tree ornaments cover the frame 2 to form the shape of a Christmas tree.

As can be seen from the above description, the above embodiment of the present disclosure achieves the following technical effects:

The present disclosure provides a rotatable Christmas tree, including a support rod assembly, a frame assembly, and a motor, where the support rod assembly includes a support rod base and a support rod fixedly connected to the support rod base; the frame assembly includes a frame and Christmas tree ornaments disposed on the frame, and the frame is provided with a connecting ring at a top; the motor is disposed at a top of the support rod, and a motor shaft of the motor is connected to the connecting ring. When the motor rotates, the motor drives the connecting ring to cause the frame and the Christmas tree ornaments on the frame to rotate, thereby providing viewers with more dynamic viewing experiences. Additionally, compared to rotatable Christmas trees available on the market, the Christmas tree provided in this technical solution has fewer parts, and the assembly between parts is simpler. Rotation is achieved merely by adding the motor on the support rod to cooperate with the connecting ring on the frame, with lower production and processing costs.

The above descriptions are merely preferred embodiments of the present disclosure and are not intended to limit the patent scope of the present disclosure. Any equivalent structural transformations made using the contents of the specification and drawings of the present disclosure under the inventive concept of the present disclosure, or any direct/indirect applications of the present disclosure in other related technical fields, should fall within the patent protection scope of the present disclosure.

What is claimed is:

1. A rotatable Christmas tree, comprising:
a support rod assembly, wherein the support rod assembly comprises a support rod base and a support rod fixedly connected to the support rod base;
a frame assembly, wherein the frame assembly comprises a frame and Christmas tree ornaments disposed on the frame, and the frame is provided with a connecting ring at a top; and
a motor, wherein the motor is disposed at a top of the support rod, and a motor shaft of the motor is connected to the connecting ring; and when the motor rotates, the motor drives the connecting ring to cause the frame and the Christmas tree ornaments on the frame to rotate.

2. The rotatable Christmas tree according to claim 1, wherein a support plate is fixedly connected to the motor shaft; and when the frame assembly is sleeved onto the motor shaft through the connecting ring, the support plate contacts the connecting ring.

3. The rotatable Christmas tree according to claim 2, wherein a motor mounting base is sleeved onto the top of the support rod, and the motor is disposed on the motor mounting base.

4. The rotatable Christmas tree according to claim 3, wherein the motor is connected to a power assembly through a conductor wire, and the power assembly comprises a storage battery and a switch for controlling the motor.

5. The rotatable Christmas tree according to claim 4, wherein the conductor wire extends downward to a connecting point between the support rod base and the support rod.

6. The rotatable Christmas tree according to claim 1, wherein the frame comprises a plurality of bracket units, the connecting ring is disposed on a central portion of each of the bracket units, and a plurality of fixing rods are disposed between the connecting ring and the bracket unit; and when the frame is mounted onto the support rod, the support rod passes through the connecting ring on the bracket unit.

7. The rotatable Christmas tree according to claim 6, wherein the bracket units are connected to each other through connecting ropes, a plurality of clips are fixedly connected to the connecting ropes, and the connecting ropes are connected to the bracket units through the clips.

8. The rotatable Christmas tree according to claim 7, wherein each of the clips comprises a detent opening configured to be snapped into the bracket unit, and an opening is formed on a side of the detent opening.

9. The rotatable Christmas tree according to claim 1, wherein the support rod base comprises a first base and a second base, and the first base and the second base are rotatably connected.

10. The rotatable Christmas tree according to claim 8, wherein the bracket unit is circular in shape; and the frame comprises the plurality of bracket units with different diameters, the diameters of the bracket units are decreased sequentially from top to bottom, and the frame formed by the bracket units is conical in shape.
